(19) United States
(12) Patent Application Publication
(10) Pub. No.: US 2022/0232297 A1
(43) Pub. Date: Jul. 21, 2022

(54) MULTI-MEDIA PROCESSING SYSTEM FOR LIVE STREAM AND MULTI-MEDIA PROCESSING METHOD FOR LIVE STREAM

(71) Applicant: AVerMedia TECHNOLOGIES, INC., New Taipei City (TW)

(72) Inventors: Ming-Chang WANG, New Taipei City (TW); Shih-Yu LIU, New Taipei City (TW); Shih-Ming LAN, New Taipei City (TW)

(21) Appl. No.: 17/578,470

(22) Filed: Jan. 19, 2022

(30) Foreign Application Priority Data
Jan. 20, 2021 (TW) 110102177

(51) Int. Cl. H04N 21/854; H04N 21/2187; H04N 21/234; G11B 27/031

(52) U.S. Cl. CPC H04N 21/854; G11B 27/031; H04N 21/234; H04N 21/2187

(57) ABSTRACT

A multi-media processing system for live stream includes a first processing module, a control module, and a second processing module. The first processing module is communicatively connected with a stream-display device. The first processing module receives a source video. The control module is connected with the first processing module, and the control module is configured to receive an effect-previewing command. The second processing module is connected with the control module and a previewing display device. The control module sends the effect-previewing command to the second processing module. The second processing module is configured to attach a video effect corresponding to the effect-previewing command to the source video. The stream-display device shows the source video, and the previewing display device shows a previewing video, wherein the previewing video includes the video effect which is attached on the source video and which is corresponding to the effect-previewing command.

### CROSS-REFERENCE TO RELATED APPLICATION

This application claims priority to Taiwan Application Serial Number 110102177, filed Jan. 20, 2021, which is herein incorporated by reference in its entirety.

### BACKGROUND

### Field of Invention

The present invention relates to a processing system and a processing method. More particularly, the present invention relates to a multi-media processing system for live stream and a multi-media processing method for live stream.

### Description of Related Art

Due to the prevalence of the community network, the user opens live stream to share personal experience, product opening, scene introduction, etc. have gradually become a trend in social activities. Personal mobile devices, communication software, imaging sensing and other technologies have matured, and how to provide more sample and effective service is a considerable important topic. Taking a live stream service as an example, in order to enhance the remote user to watch the appeal of live video, the live streamer will consider adding video effects in the live video to combine activities or issues in its live stream. However, the live streamer cannot let the remote users see the editing process during the real-time screen play, which will cause the problem of screen confusion, and will also cause the remote users to give up watching, resulting in a decrease in the number of viewers.

At present, the act of editing videos in the live stream is that the live video is determined by switching through the switch of the switcher and the video of the original video and the edited special effects to determine the live video of the output. However, such practical effects are low, and additional software and/or hardware costs are required to achieve the switcher, resulting in a waste of human development and software and hardware costs.

### SUMMARY

SUMMARY is intended to provide a simplified abstract of the present disclosure, so that readers have a basic understanding of the content of the case. SUMMARY is not a complete overview of the present disclosure, and it is not intended to identify important/critical elements of the embodiments of the present disclosure or to delimit the scope of the present disclosure.

According to one embodiment of the present disclosure, it is disclosed a multi-media processing system for live stream comprises a first processing module, a control module, and a second processing module. The first processing module is communicatively connected with a stream-display device, wherein the first processing module is configured to receive a source video, and the stream-display device is configured to show the source video. The control module is connected with the first processing module, wherein the control module is configured to receive an effect-previewing command. The second processing module is connected with the control module and an previewing display device, wherein the control module sends the effect-previewing command to the second processing module. The second processing module is configured to attach a video effect corresponding to the effect-previewing command to the source video. The stream-display device shows the source video, the previewing display device shows a previewing video. The previewing video comprises the video effect which is attached on the source video and which is corresponding to the effect-previewing command.

According to another embodiment of the present disclosure, it is disclosed a multi-media processing method for live stream which comprises the following steps: receiving a source video for showing a source video on a stream-display device; receiving an effect-previewing command to attach an video effect corresponding to the effect-previewing command to the source video; and showing the source video on the stream-display device, and showing a previewing video on an previewing display device, wherein the previewing video comprises the video effect which is attached on the source video and which is corresponding to the effect-previewing command.

### BRIEF DESCRIPTION OF THE DRAWINGS

The invention can be more fully understood by reading the following detailed description of the embodiment, with reference made to the accompanying drawings as follows:

FIG. 1 is a schematic diagram of a multi-media processing system for live stream according to some embodiment of the present disclosure.

FIG. 2 is a flowchart of a multi-media processing method for live stream according to some embodiment of the present disclosure.

### DETAILED DESCRIPTION

The following disclosure provides many different embodiments for implementing the different features of the present disclosure. Embodiments of components and arrangements are described below to simplify the present disclosure. Of course, these embodiments are exemplary only and are not intended to be limiting. For example, the terms “first” and “second” are used to describe elements in the present disclosure, only to distinguish the same or similar elements or operations, and the terms are not used to limit the technical elements of the present disclosure, nor is it intended to limit the order or sequence of operations. In addition, the reference numerals and/or letters may be repeated in each embodiment, and the same technical terms may use the same and/or corresponding reference numerals in each embodiment. This repetition is for the purpose of brevity and clarity, and does not in itself indicate a relationship between the various embodiments and/or configurations discussed.

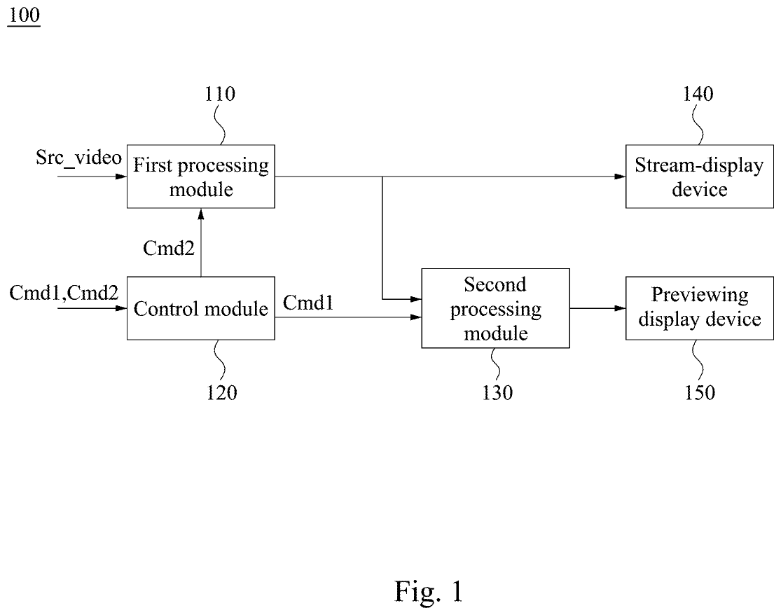

Please refer to FIG. 1, it is a schematic diagram of a multi-media processing system for live stream 100 according to some embodiment of the present disclosure. As shown in FIG. 1, the multi-media processing system 100 for live stream includes a first processing module 110, a control module 120, and a second processing module 130. The first processing module 110 is connected with the control module 120. The control module 120 is connected with the second processing module 130.

In some embodiments, the first processing module 110 receives a source video Src_video. For example, the first processing module 110 can be connected with an image capture device (not shown), for example, cameras, electronic devices with image sensors, video capture cards, video capture boxes or any electronic device that can capture images, such as an image capture program that can execute cloud services or an electronic device installed with image capture software can continuously receive images captured by the image capture device.

In some embodiments, the first processing module 110 is communicatively connected with a stream-display device 140. The stream-display device 140 can be disposed at a remote device, and communicates with the first processing module 110 through a wired or wireless network, so that the user can watch the live video.

The multi-media processing system 100 for live stream of the present disclosure can allow the live video provider to perform effects editing operations while performing live streaming, without affecting the watching of remote users.

In some embodiments, the second processing module 130 receives the source video Src_video through an image splitting module (not shown). For example, the image splitting module can be connected with the first processing module 110, and after the image splitting module receives the source video Src_video, the image splitting module splits and outputs the source video Src_video to the stream-display device 140 and the second processing module 130. In some embodiments, after the source video Src_video is received, the source video Src_video is stored or temporarily stored in a buffer of the image splitting module, so that the source video Src_video can be output to the stream-display device 140 and the second processing module 130 substantially synchronously through buffering process of the buffer. Here, substantial synchronization may refer to simultaneous, or a slight delay due to buffering process. It is worth mentioning that the source video Src_video can be streamed to the remote end after an image processing such as image compression is performed to the source video Src_video, so that the stream-display device 140 can play the streaming video subsequently. For example, the splitting module can be connected with a video output module (with image compression function) (not shown), and the video output module can be communicatively connected with other remote stream-display devices through network streaming. In order to simplify the content of the description, the processing method of the streaming image will not be repeated. In addition, in the above-mentioned example, the second processing module 130 may receive the source video Src_video after the stream is split by the splitting module.

In some embodiments, the second processing module 130 is connected with a previewing display device 150. The previewing display device 150 can be a display device seted at the local end. For example, the previewing display device 150 is configured to show the source video Src_video, for the live streamer to watch the video through the previewing display device 150 to edit the video effect. It is worth mentioning that the control module 120 can be connected to an electronic device or module that can execute video play and editing programs, so that the live streamer can edit the video effect while watching the video. The method of editing video effect will be explained later.

In some embodiments, the control module 120 receives the effect-previewing command Cmd1. For example, if the live streamer wants to attach and preview the effect such as a star in the upper left corner of the screen, the control module 120 will receive the effect-previewing command Cmd1 for attaching a star effect in the upper left corner of the screen.

In some embodiments, the control module 120 sends the effect-previewing command Cmd1 to the second processing module 130, so that the second processing module 130 attaches a video effect to the source video Src_video, and the video effect corresponds to the effect-previewing command Cmd1. In some embodiments, the previewing display device 150 shows a previewing video, and the stream-display device 140 shows the source video Src_video, wherein the previewing video includes the video effect which is attached to the source video Src_video and which is corresponding to the effect-previewing command Cmd1. In this case, the previewing video could include the source video Src_video attaching the video effect. At this time, the video that the remote user (viewer) watches on the stream-display device 140 is only the source video Src_video transmitted from the first processing module 110, and the remote user (viewer) will not watch the video effect, for example, the star effect. In the other words, at this time, the first processing module 110 does not process the source video Src_video with the effect attached function (bypass the processing of the effect attached function), so the second processing module 130 can receive the video (the video effect has not yet been attached) by the image splitting module (not shown), and then attach the video effect to the aforementioned video, wherein the video effect corresponds to the effect-previewing command Cmd1. The video with the video effect shown on the previewing display device 150 is only the process of editing the effect by the live streamer at the local end, and at the same time, the live streamer can know the effect show at the near end through the previewing video shown on the previewing display device 150. In other words, the live streamer can edit the video effect on the local end during the live stream, and the editing process will not affect the live video watched by the remote users. It is worth mentioning that there may be a time difference between showing the source video Src_video on the stream-display device 140 and showing the previewing video on the previewing display device 150, and the time difference can be a network delay or a slight delay caused by the device processing the video. In some embodiments, there is no time difference or only a slight time difference between showing the source video Src_video by the stream-display device 140 and showing the previewing video by the previewing display device 150. It should be noted that the time difference refers to the time difference between the time when the same video image is shown on the stream-display device 140 and the time when the same video image is shown on the previewing display device 150.

In some embodiments, the effect-previewing command Cmd1 corresponds to a touch control signal, for example, the live streamer presses on the touch display panel or selects and presses with an input/output device (not shown) such as a keyboard or a mouse, and generates a control signal. When the touch control signal is a long press touch signal, the control module 120 will receive the effect-previewing command Cmd1, so that the second processing module 130 can subsequently process the source video Src_video according to the effect-previewing command Cmd1.

After the live streamer selects and edits the video effect, the live streamer decides the video effect to be implemented (that is, the video effect to be watched by the remote users). At this time, the live streamer can also generate commands through the touch control signal.

In some embodiments, when the touch control signal is a short press touch signal, the control module 120 will receive the new attached effect command Cmd2. Since the new attached effect command Cmd2 is a command to be applied to the live stream, the control module 120 will send the new attached effect command Cmd2 to the first processing module 110. The first processing module 110 processes the source video Src_video according to the new attached effect command, for example, the first processing module 110 superimposes an animation special effect of clapping hands on the screen of the source video Src_video.

In some embodiments, after the first processing module 110 receives the new attached effect command Cmd2, the first processing module 110 attaches the video effect corresponding to the new attached effect command Cmd2 to the source video Src_video (for example, an animation effect of clapping hands is superimposed on the top of the screen), so that the stream-display device 150 shows a live effect video, wherein the live effect video includes the video effect which is corresponding to the new attached effect command Cmd2 and attached on the source video Src_video. At this time, the remote user will watch the live video with the video effect. It is worth mentioning that the second processing module 130 will not receive the new attached effect command Cmd2. After the first processing module 110 attaches the video effect to the source video Src_video, the second processing module 130 can receive the video with the video effect which has been attached through the image splitting module (not shown). In this way, when the effect preview is performed on the live video subsequently, the previewing video shown by the previewing display device 150 will perform the effect preview based on the video whose the video effect has been attached.

In some embodiments, the aforementioned video effect includes a video control function key which is shown on the source video, a video effect key which is shown on the source video, and the video effect which is corresponding to the video effect key. The video control function key are, for example, function keys shown on the screen such as video play, pause, fast forward, reverse, and stop. The video effect key is such as the function key for attaching a static image effects (such as static pictures) or the function key for a dynamic image effects (such as clap effect), the function key for a scene effects (such as zombie passing, crow flying, etc.), the function key for a filter effects, the function key for an anchor effects (such as face mapping, face painting, dressing effects, etc.), the function key for face effects (such as skin softening, whitening, color adjustment, brightness adjustment, etc.), the function key for an image sharpening or blurring, sound effects. The video effect corresponds to the video effect key, wherein the video effect is such as the static image effects (such as static pictures) or the dynamic image effects (such as clap effect), the scene effects (such as zombie passing, crow flying, etc.), the filter effects, the anchor effects (such as face mapping, face painting, dressing effects, etc.), the face effects (such as skin softening, whitening, color adjustment, brightness adjustment, etc.), the image sharpening or blurring, sound effects.

In some embodiments, the multi-media processing system 100 can be implemented by a combination of software/hardware or a hardware, which is not limited herein. In addition, the multi-media processing system 100 can be presented by a local computer which is coupled with a computer peripheral device, for example, the local computer can send the streaming image to a remote stream-display device 140 for showing through the network, and the local computer can be electrically coupled with the computer peripheral devices. The previewing display device 150 is disposed on the computer peripheral device, wherein the first processing module 110, the splitting module, the control module 120, and the second processing module 130 can be implemented in the computer through software or hardware. Of course, the first processing module 110, the splitting module, the control module 120, and the second processing module 130 can also be implemented on computer peripheral devices, which are not limited herein.

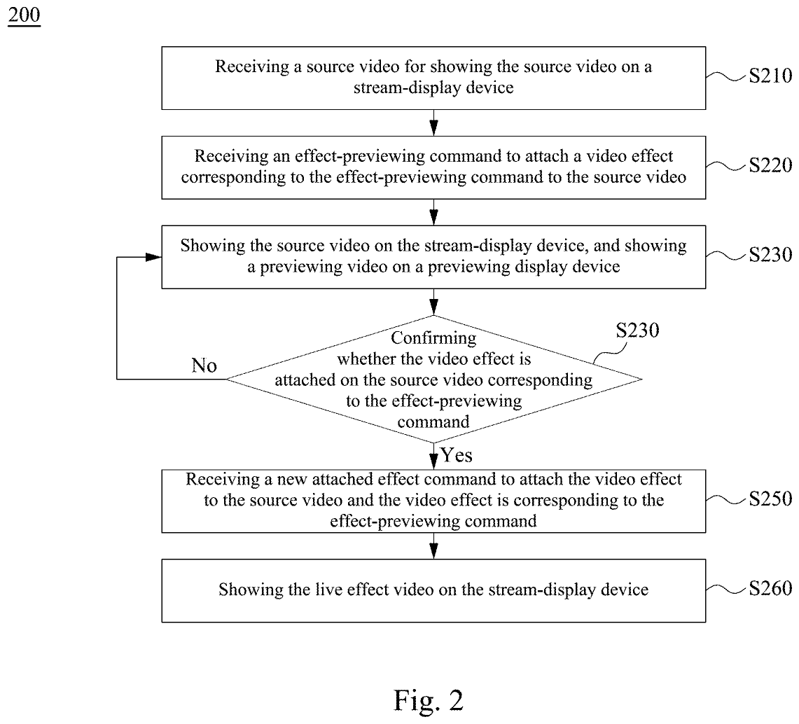

Please refer to FIG. 2, it is a flowchart of a multi-media processing method for live stream 200 according to some embodiment of the present disclosure. The multi-media processing method 200 for live stream can be executed by the multi-media processing system 100 for live stream in FIG. 1. Please refer to FIG. 1 and FIG. 2 together for the following description.

In step S210, a source video Src_video is received for showing the source video Src_video on a stream-display device 140. In some embodiments, the first processing module 110 receives the source video Src_video from the image capture device (not shown in FIG. 1). Next, when the source video Src_video is transmitted from the first processing module 110 to the stream-display device 140, it is also split to the second processing module 130. In some embodiments, the stream-display device 140 and the previewing display device 150 both show the image which have not been attached the effect, or the image which waits for attaching the effect.

In step S220, the control module 120 receives an effect-previewing command Cmd1 to attach a video effect corresponding to the effect-previewing command Cmd1 to the source video Src_video. For example, if the live streamer wants to attach and preview an effect such as a star in the upper left corner of the screen, the control module 120 will receive an effect-previewing command Cmd1 for attaching a star effect in the upper left corner of the screen.

In step S230, the source video Src_video is shown on the stream-display device 140, and a previewing video is shown on a previewing display device 150. In some embodiments, in the process of the live streamer how to edit the video effect, the live video played on the stream-display device 140 is the video that has not been edited with the video effect. In other words, while making the stream-display device 140 can play the source video Src_video, the previewing display device 150 shows the previewing video with the video effect. In some embodiments, the source video Src_video can be an image that has undergone the above-mentioned video effect processes (such as the video effect has been attached or the video effect fusion has been completed). The image that has undergone the video effect processing can be further edited again, for example, the second processing module 130 uses the newly received effect-previewing command Cmd1 again to process the image that has been processed by the video effect, so that the image with the previously attached and merged the video effect is played on the stream-display device 140. At the same time, the previewing display device 150 previews and displays the previewing video with the effect to be attached this time based on the video whose the video effect has been attached. Therefore, the user can continuously perform the effect preview/attach effect procedure on the image, so as to gradually enrich the effect of the image screen.

In step S240, the video effect is confirmed that whether it is attached on the source video corresponding to the effect-previewing command. In some embodiments, the live streamer can press on the touch display panel or select the control signal generated by pressing an input/output device (not shown) such as a keyboard or a mouse. For example, the touch control signal includes a long press touch signal and a short press touch signal. When the touch control signal is the long press touch signal, it means that it has not yet decided to attach the effect to the source video Src_video for the user to watch, then go back to step S230, the control module 120 receives the effect-previewing command Cmd1, so that the second processing module 130 can subsequently process and preview the video with the video effect according to the effect-previewing command Cmd1.

In some embodiments, at step S240, when the touch control signal is the short press touch signal, it means that it is determined to attach the effect to the source video Src_video for the user to watch, and then step S250 is executed.

In step S250, the control module 120 receives a new attached effect command, so as to attach the video effect to the source video Src_video and the video effect is corresponding to the new attached effect command. In some embodiments, the control module 120 sends the new attached effect command Cmd2 to the first processing module 110, so that the first processing module 110 processes the source video Src_video according to the new attached effect command, for example, an animation effect of clapping hands is superimposed on the screen of the processing source video Src_video.

In step S260, the live effect video is shown on the stream-display device 140. In some embodiments, the live effect video includes the video effect which is corresponding to the new attached effect command Cmd2 and attached on the source video Src_video, so that the remote user can watch the live stream video with the video effect.

In summary, the multi-media processing system for live stream and the multi-media processing method for live stream of the present disclosure allow the live streamer to watch the live video by himself at the local end and edit the video effect of the live video at the same time. The editing process will not affect the watching experience of the remote user, and the remote user will only watch the editing result that have completed the effect design, so as to avoid the editing process of the live streamer to affect the watching attention of the remote user. Furthermore, the prior art provides an editing method for the live video, which uses a switcher to switch between the original video and the edited effect video to determine the output live video. On the other hand, in the present disclosure, there is no need to design the switcher, which can save the design coast of the software and/or the hardware. Moreover, the control command is send to the first processor or the second processor through the control module so as to achieve the effect of previewing the local video and playing the live video.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A multi-media processing system for live stream, comprising:
a first processing module, communicatively connected with a stream-display device, wherein the first processing module is configured to receive a source video, wherein the stream-display device is configured to show the source video;
a control module, connected with the first processing module, wherein the control module is configured to receive an effect-previewing command; and
a second processing module, connected with the control module and a previewing display device, wherein the control module sends the effect-previewing command to the second processing module, and the second processing module is configured to attach a video effect corresponding to the effect-previewing command to the source video;
wherein the stream-display device shows the source video, and the previewing display device shows a previewing video, wherein the previewing video comprises the video effect which is attached on the source video and which is corresponding to the effect-previewing command.

2. The multi-media processing system for live stream of claim 1, wherein the effect-previewing command corresponds to a touch control signal, when the touch control signal is a long press touch signal, the second processing module processes the source video according to the effect-previewing command.

3. The multi-media processing system for live stream of claim 1, wherein the control module is further configured to receive a new attached effect command, and send the new attached effect command to the first processing module;
wherein the new attached effect command corresponds to a touch control signal, when the touch control signal is a short press touch signal, the first processing module processes the source video according to the new attached effect command.

4. The multi-media processing system for live stream of claim 3, wherein the first processing module attaches the video effect to the source video and the video effect corresponds to the new attached effect command, so that the stream-display device shows a live effect video, wherein the live effect video comprises the video effect which is corresponding to the new attached effect command and attached on the source video.

5. The multi-media processing system for live stream of claim 1, wherein the video effect comprises a video control function key which is shown on the source video, a video effect key which is shown on the source video, and the video effect which is corresponding to the video effect key.

6. A multi-media processing method for live stream, comprising:
receiving a source video for showing the source video on a stream-display device;
receiving an effect-previewing command to attach a video effect corresponding to the effect-previewing command to the source video; and
showing the source video on the stream-display device, and showing a previewing video on a previewing display device, wherein the previewing video comprises the video effect which is attached on the source video and which is corresponding to the effect-previewing command.

7. The multi-media processing method for live stream of claim 6, wherein the effect-previewing command corresponds to a touch control signal, when the touch control signal is a long press touch signal, the source video is processed according to the effect-previewing command.

8. The multi-media processing method for live stream of claim 6, further comprising:
receiving a new attached effect command, wherein the new attached effect command corresponds to a touch control signal; and
when the touch control signal is a short press touch signal, the source video is processed according to the new attached effect command.

9. The multi-media processing method for live stream of claim 8, further comprising:
attaching the video effect to the source video and the video effect corresponds to the new attached effect command, so that the stream-display device shows a live effect video, wherein the live effect video comprises the video effect which is corresponding to the new attached effect command and attached on the source video.

10. The multi-media processing method for live stream of claim 6, wherein the video effect comprises a video control function key which is shown on the source video, a video effect key which is shown on the source video, and the video effect which is corresponding to the video effect key.
